(19) United States
(12) Patent Application Publication
(10) Pub. No.: US 2024/0184985 A1
(43) Pub. Date: Jun. 6, 2024

(54) INFORMATION REPRESENTATION STRUCTURE ANALYSIS DEVICE, AND INFORMATION REPRESENTATION STRUCTURE ANALYSIS METHOD

(71) Applicant: HITACHI, LTD., Tokyo (JP)

(72) Inventors: Yasushi MIYATA, Tokyo (JP); Tadashi TAKEUCHI, Tokyo (JP)

(21) Appl. No.: 18/285,886

(22) PCT Filed: Mar. 11, 2022
(86) PCT No.: PCT/JP2022/010905

§ 371 Date: Oct. 6, 2023

(30) Foreign Application Priority Data
Apr. 8, 2021 (JP) 2021-065806

(51) Int. Cl. G06F 40/253; G06F 40/186

(52) U.S. Cl. CPC G06F 40/253; G06F 40/186

(57) ABSTRACT

An information representation structure analysis device: stores an information representation template for each combination of an information representation grammar and a support information type, the information representation template being a template used to generate an information representation pattern being a program code for implementing a function of extracting an extraction target, the support information type being a category of support information being information used in extraction of the extraction target; identifies the information representation template to be used to generate the information representation pattern for extraction of the extraction target from an atypycal document, based on the information representation grammar and the support information type identified for the information representation; and generates the information representation pattern by applying the extraction target and basis information to the identified information representation template, the basis information being a basis in extraction of the extraction target from the information representation.

### TECHNICAL FIELD

The present invention relates to an information representation structure analysis device, and an information representation structure analysis method.

### BACKGROUND ART

PTL 1 describes a system configured to enable efficient and accurate recognition of documents in the case where texts are extracted from images using optical character recognition (OCR) technology, with the images obtained by reading printed documents or typed documents with an image scanner. The system recognizes the layout of the document (column setting, author, title, footnote, and the like) using a two-dimensional adaptation of a statistical analysis algorithm to grammatically analyze the visual structure of the document, and interprets the structural components of the document.

### CITATION LIST

### Patent Literature

PTL 1 Published Japanese Translation of PCT International Application No. 2009-500755

### SUMMARY OF THE INVENTION

### Technical Problem

The system described in PTL 1 recognizes the layout of the document by grammatically analyzing the visual structure of the document, and interprets the structural components of the document. However, the system described in PTL 1 does not use information other than texts and the two-dimensional arrangement between the texts, for example, information that is included in the document and that provides useful clues for interpreting the structure of the document, such information including control characters such as tables, spaces, tabs, and HTML (hypertext markup language) tags, information described outside the document such as headers and footers, invisible document information (information that does not appear on the surface of the document), and the like. Accordingly, the system cannot always efficiently extract target information from a atypycal document.

The present invention has been conceived in view of this background, and has as an object to provide an information representation structure analysis device and an information representation structure analysis method that can efficiently extract target information from a atypycal document.

### Solution to the Problem

In order to solve the above issue, an information representation structure analysis device is configured using an information processing device, and comprises a storage part configured to store an information representation being a mode of representation of information in a atypycal document, an extraction target being information intended to be extracted from the information representation, and basis information being information to be a basis in extraction of the extraction target from the information representation; an information representation grammar identification part configured to identify an information representation grammar based on the extraction target and the basis information, the information representation grammar being a grammar describing the information representation to be an extraction source of the extraction target; and a support information type identification part configured to identify a support information type of support information being information used in the extraction of the extraction target from the information representation, the support information type being a category of the support information based on a structure of the information representation. The storage part stores an information representation template for each combination of the information representation grammar and the support information type, the information representation template being a template used for generation of an information representation pattern being a program code for implementing a function of extracting the extraction target. The information representation structure analysis device comprises an information representation template retrieval part configured to identify the information representation template to be used for the generation of the information representation pattern to be used for extraction of the extraction target from the atypycal document, based on the information representation grammar and the support information type identified for the information representation; and an information representation pattern generation part configured to generate the information representation pattern by applying the extraction target and the basis information to the identified information representation template.

Other problems and solutions thereto disclosed in the present application will be made apparent by the detailed and the drawings.

### Advantageous Effects of the Invention

According to the present invention, it is possible to efficiently extract target information from a atypycal document.

### BRIEF DESCRIPTION OF THE DRAWINGS

FIG. 1 is a diagram illustrating a schematic configuration of a document information management system in a first embodiment.

FIG. 2 is an example of an information processing device forming the document information management system.

FIG. 3 is an example of a atypycal document.

FIG. 4 is an example of an information representation pattern.

FIG. 5 is an example of an information representation template.

FIG. 6 is an example of an information representation template table.

FIG. 7 is a flowchart explaining an information representation pattern generation process.

FIG. 8 is a flowchart explaining an information representation grammar identification process.

FIG. 9 is a flowchart explaining a support information type identification process.

FIG. 10 is a diagram illustrating a schematic configuration of a document information management system in a second embodiment.

FIG. 11 is a flowchart explaining an identification assist information obtaining process.

FIG. 12 is an example of an identification assist information obtaining screen.

FIG. 13 is an example of the identification assist information obtaining screen.

FIG. 14 is an example of the identification assist information obtaining screen.

FIG. 15 is an example of the identification assist information obtaining screen.

FIG. 16 is an example of the identification assist information obtaining screen.

FIG. 17 is an example of the identification assist information obtaining screen.

FIG. 18 is an example of the identification assist information obtaining screen.

FIG. 19 is a diagram illustrating a schematic configuration of a document information management system in a third embodiment.

FIG. 20 is a flowchart explaining an information representation pattern verification process.

FIG. 21 is an example of an information representation pattern verification result display screen.

### DETAILED DESCRIPTION

Embodiments are described below with reference to the drawings. Note that the following description and drawings are merely examples for explaining the present invention, and omissions and simplifications are made as necessary to clarify the explanation. The present invention can be implemented in various modes other than those described herein. Unless particularly specified, the number of each of components may be either one or two or more.

In the following description, the same or similar configurations are denoted by the same reference numerals, and overlapping description is omitted in some cases. Moreover, in the following description, the letter “S” attached before reference numerals means processing step. Furthermore, in the following description, various pieces of information are described using terms such as “information”, “data”, and “table”. However, each of the various pieces of information may be handled in a data structure other than that given as an example.

### First Embodiment

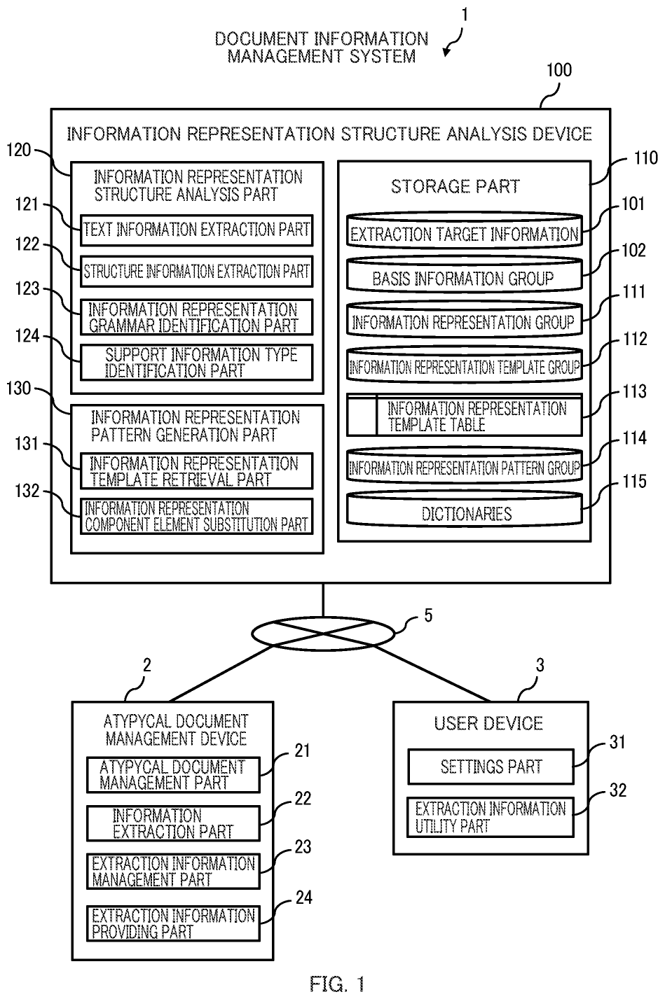

FIG. 1 illustrates a schematic configuration of an information processing system (hereinafter, referred to as “document information management system 1”) explained as a first embodiment. As illustrated in FIG. 1, the document information management system 1 includes a atypycal document management device 2, a user device 3, and an information representation structure analysis device 100. These devices are each configured using an information processing device (computer), and are coupled to one another via a communication network 5 in a state where they can perform bidirectional communication with one another. The communication network 5 is, for example, a LAN (local area network), a WAN (wide area network), the Internet, a dedicated line, or various public communication networks.

The atypycal document management device 2 extracts information (hereinafter, referred to as “extraction information”) intended to be extracted by a user from documents with no fixed form (documents (for example, rich text format) with varying formats depending on issuers such as business forms, specifications, financial statements, various registration sheets, and the like; hereinafter, referred to as “atypycal documents”), and provides the extraction information to the user via the user device 2.

The atypycal documents each includes text data (hereinafter, referred to as “text”) of words and sentences, structural information (tables, spaces, tabs, information described outside the document, invisible document information (regular expressions, dictionary matches, meta information, and control characters such as HTML (hypertext markup language) tags), and the like; hereinafter, referred to as “structure information”). Modes of representation of information included in the atypycal document (representation of information by texts and structure information) are collectively referred to as “information representation”. For example, the information representation is extracted from document data of a predetermined data format handled by application software such as word processing software and data describing a web page, as well as from image data (image data obtained by an image scanner) using an optical character recognition (OCR) technology.

As illustrated in FIG. 1, the atypycal document management device 2 includes a atypycal document management part 21, an information extraction part 22, an extraction information management part 23, and an extraction information providing part 24.

Among these parts, the atypycal document management part 21 obtains the atypycal document through an input performed by the user via the user device 3, provision from other information processing devices via the communication network 5, or the like, and manages the obtained atypycal document.

The information extraction part 22 obtains (extracts) the extraction information from the atypycal document. Note that the information extraction part 22 obtains the extraction information from the atypycal document by executing program code (or pseudocode) (hereinafter, referred to as “information representation pattern”) for implementing a function of obtaining the extraction information from the atypycal document (by performing pattern matching of the information representation). The information representation pattern is generated by the information representation structure analysis device 100. The user can also edit the information representation pattern via the user device 3.

The extraction information management part 23 manages the extraction information obtained by the information extraction part 22. The extraction information providing part 24 provides the extraction information managed by the extraction information management part 23 to the user device 3.

The user device 3 includes a settings part 31 and an extraction information utility part 32. The settings part 31 performs various settings required for the information representation structure analysis device 100 to perform generation and editing of the information representation pattern. The extraction information utility part 32 requests the atypycal document management device 2 for the extraction information requested by the user, receives the extraction information sent from the atypycal document management device 2, and provides the extraction information to the user.

The information representation structure analysis device 100 generates the information representation pattern, and provides the information representation pattern to the atypycal document management device 2. As illustrated in FIG. 1, the information representation structure analysis device 100 includes a storage part 110, an information representation structure analysis part 120, and an information representation pattern generation part 130.

As illustrated in FIG. 1, the storage part 110 stores extraction target information 101, a basis information group 102, an information representation group 111, an information representation template group 112, an information representation template table 113, an information representation pattern group 114, and dictionaries 115.

The extraction target information 101 includes one or more extraction targets intended to be extracted from the atypycal document by the user. For example, the user sets the extraction target information 101 via the user device 2.

The basis information group 102 includes one or more pieces of basis information that are to be the basis of extraction of the extraction target from the information representation. For example, the user sets the basis information group 102 via the user device 2.

The information representation group 111 includes one or more information representations extracted from the atypycal document. For example, the user sets the information representation group 111 via the user device 2. For example, when the information representation pattern to be used for the extraction of the extraction information from many atypycal documents is intended to be generated, the user registers the information representations extracted from these atypycal documents in the information representation structure analysis device 100 as the information representation group 111.

The information representation template group 112 includes one or more program codes (hereinafter, referred to as “information representation template”) that are templates of the information representation pattern. Details of the information representation template are described later.

The information representation template table 113 is referred to by the information representation structure analysis part 120 in selection of the information representation template to be used for generation of the information representation pattern.

The information representation pattern group 114 includes one or more information representation patterns generated by the information representation pattern generation part 130.

The dictionaries 115 include various dictionaries (word dictionary, regular expression dictionary, and the like) used by the information representation structure analysis part 120 and the information representation pattern generation part 130.

The information representation structure analysis part 120 specifies information (information representation grammar and support information type to be described later) to be used for retrieval of the information representation template from the information representation template table 113, based on the information representation (text, structure information) in the information representation group 111.

As illustrated in FIG. 1, the information representation structure analysis part 120 includes a text information extraction part 121, a structure information extraction part 122, an information representation grammar identification part 123, and a support information type identification part 124.

Among these parts, the text information extraction part 121 extracts the text from the information representation. Moreover, the structure information extraction part 122 extracts the structure information from the information representation. Furthermore, the information representation grammar identification part 123 identifies the grammar (hereinafter, referred to as “information representation grammar”) that describes the information representation, based on the text and the structure information extracted from the information representation. Moreover, the support information type identification part 124 identifies the later-described support information type corresponding to the information representation, from the information representation template table 113 based on the text and the structure information extracted from the information representation.

The information representation pattern generation part 130 illustrated in FIG. 1 retrieves the information representation template from the information representation template table 113, based on the information representation grammar and the support information type identified by the information representation structure analysis part 120, and applies the specific extraction target (text and the like) and the basis information (configuration information and the like) to the retrieved information representation template to generate the information representation pattern.

As illustrated in FIG. 1, the information representation pattern generation part 130 includes an information representation template retrieval part 131 and an information representation component element substitution part 132.

Among these parts, the information representation template retrieval part 131 retrieves the information representation template corresponding to the combination of the information representation grammar and the support information type identified by the information representation structure analysis part 120, from the information representation template table 113.

Moreover, the information representation component element substitution part 132 generates the information representation template by applying (substituting) the specific extraction target (text and the like) and the basis information (configuration information and the like) to the information representation template retrieved by the information representation template retrieval part 131.

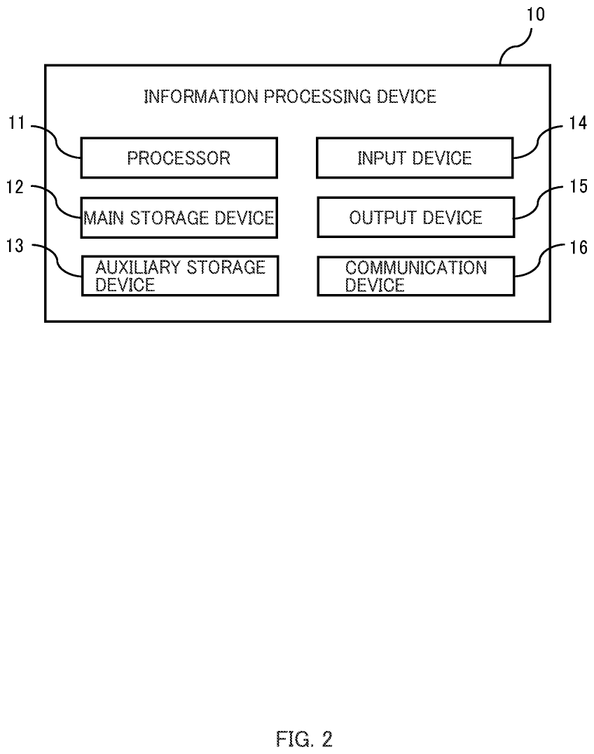

FIG. 2 illustrates a hardware configuration example of the information processing devices (atypycal document management device 2, user device 3, and information representation structure analysis device 100) forming the document information management system 1. An information processing device 10 illustrated as an example includes a processor 11, a main storage device 12, an auxiliary storage device 13, an input device 14, an output device 15, and a communication device 16. The information processing device 10 is, for example, a personal computer, an office computer, a server device, a smartphone, a tablet, or the like.

The information processing device 10 may be partially or entirely implemented using virtual information processing resources provided a virtualization technology, a process space isolation technology, or the like, as in, for example, a virtual server provided by a cloud system. Moreover, all or some of the functions provided by the information processing device 10 may be implemented by, for example, a service provided by a cloud system via an API (application programming interface). Furthermore, all or some of the functions provided by the information processing device 10 may be implemented using, for example, SaaS (software as a service), PaaS (platform as a service), IaaS (infrastructure as a service), or the like.

Note that, for example, at least two or more of the atypycal document management device 2, the user device 3, and the information representation structure analysis device 100 may be implemented by the same information processing device 10 (common hardware).

The processor 11 illustrated in FIG. 2 is formed with, for example, a CPU (central processing unit), an MPU (micro processing unit), a GPU (graphics processing unit), an FPGA (field programmable gate array), an ASIC (application-specific integrated circuit), an AI (artificial intelligence) chip, or the like.

The main storage device 12 is a device that stores programs and data, and is, for example, a ROM (read-only memory), a RAM (random access memory), a non-volatile memory (NVRAM (non-volatile RAM)), or the like.

The auxiliary storage device 13 is, for example, an SSD (solid state drive), a hard disk drive, an optical storage device (CD (compact disc), DVD (digital versatile disc), or the like), a storage system, an IC card, an SD card, a read/write device of a storage medium such as an optical storage medium, a storage area of a cloud server, or the like. Programs and data can be read into the auxiliary storage device 13 via the reading device of the storage medium or the communication device 16. The programs and data recorded (stored) in the auxiliary storage device 13 are read into the main storage device 12 as needed.

The input device 14 is an interface that receives inputs from the outside, and is, for example, a keyboard, a mouse, a touch panel, a card reader, a stylus-input type tablet, an audio input device, or the like.

The output device 15 is an interface that outputs various pieces of information such as a course of processing and processing results. The output device 15 is, for example, a display device (liquid crystal monitor, LCD (liquid crystal display), graphics card, or the like) that visualizes the above various pieces of information, a device (audio output device (speaker or the like)) that turns the above various pieces of information into audio, or a device (printing device or the like) that turns the above various pieces of information into characters. Note that, for example, the configuration may be such that the information processing device 10 exchanges information with other devices via the communication device 16.

The input device 14 and the output device 15 form a user interface that implements interactive processing (reception of information, presentation of information, and the like) with the user.

The communication device 16 is a device that implements communication with other devices. The communication device 16 is a wired or wireless communication interface that implements communication with the other devices via the communication network 5, and is, for example, an NIC (network interface card) a wireless communication module, a USB module, or the like.

For example, an operating system, a file system, a DBMS (database management system) (relational database, NoSQL, or the like), a KVS (key-value store), or the like may be introduced into the information processing device 10.

The processor 11 of the information processing device 10 forming each of the atypycal document management device 2, the user device 3, and the information representation structure analysis device 100 implements the functions of the atypycal document management device 2, the user device 3, and the information representation structure analysis device 100 by reading and executing the programs stored in the main storage device 12 of the information processing device 10 forming the corresponding device or by using the hardware (FPGA, ASIC, AI chip, or the like) of the information processing device 10 forming the corresponding device.

The atypycal document management device 2, the user device 3, and the information representation structure analysis device 100 store the above various pieces of information (data) as, for example, tables of databases or files managed by a file system.

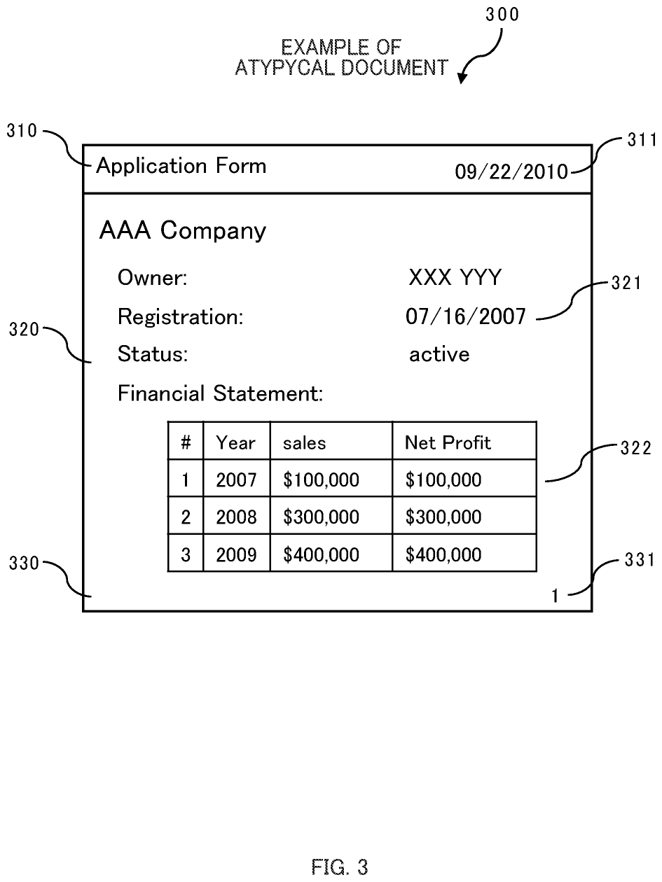

FIG. 3 illustrates an example of the atypycal document. The atypycal document 300 illustrated as an example is a document filed by an organization such as a corporation when the organization applies for financing from a financial institution. The atypycal document 300 includes text and various pieces of structure information (control characters such as tables, spaces, tabs, and HTML tags, information described outside the document, invisible document information, and the like) as the information representations.

As illustrated in FIG. 3, the atypycal document 300 illustrated as an example includes sections of a header 310, a body 320, and a footer 330. An application date 311 is given in the header 310 among these sections. A company registration date 321 and a financial statement 322 indicating a financial status of the company are described in the body 320. A page number 331 is given in the footer 330.

In this case, the company registration date 321 given in the body 320 includes texts of “Registration” and “07/16/2007” as the information representation, and includes such structure information that these texts are described in the same line. For example, grasping this information representation as a pattern and generating the information representation pattern (program code) allows the company registration date to be automatically obtained from various atypycal documents by means of pattern matching.

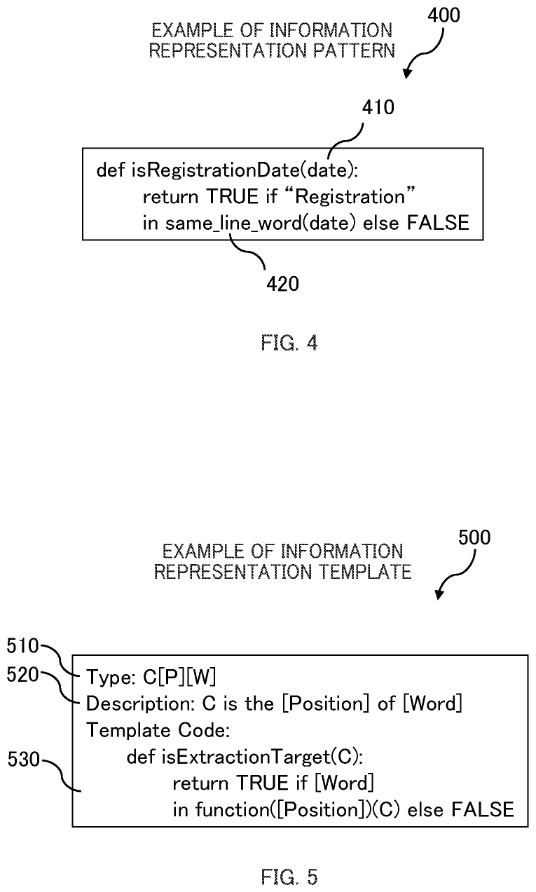

FIG. 4 illustrates an example of the information representation pattern. The information representation pattern 400 illustrated as an example implements a function of determining whether a result of a function “same_line_word” 420 includes the word “Registration” or not, the function “same_line_word” 420 using a date 410 included in the document as an input and obtaining words present in the same line as the date 410. The information representation pattern 400 illustrated as an example returns “TRUE” when the execution result of the function “same_line_word” 420 includes the word “Registration”, and returns “FALSE” when the execution result does not include the word “Registration”.

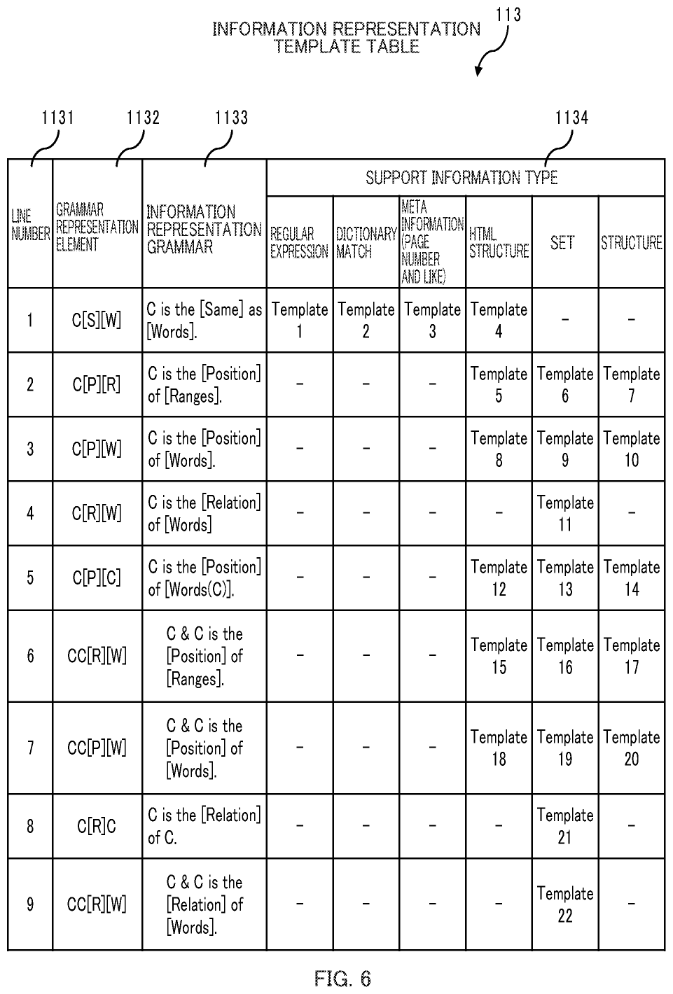

FIG. 5 is an example of an information representation template used to generate the information representation pattern 400 illustrated as an example in FIG. 4. The information representation template 500 illustrated as an example includes sections of “type” 510, “description” 520, and “template code” 530.

In the “type” 510, there is described a symbol string (“C[P] [W]” in the present example) noted by brackets and initials of elements (in the present example, C (information extraction target), [Position], and [Word]; hereinafter, referred to as “grammar representation elements”) of the information representation grammar of the information representation that is the target of the information representation template 500. Note that [Position] and [Word] noted with brackets are targets of substitution in the case where the information representation template is converted to the information representation pattern.

The “Description” 520 contains information explaining a logic of the information representation template in natural language. In the present example, information indicating that “C (information extraction target) is in a predetermined positional relation (Position) with a word or a word group” is described in the “Description” 520.

The “Template Code” 530 describes a template of a program code expressing the logic of the information representation. Replacing bracketed portions of the “Template Code” 530 with specific contents generates the information representation pattern. For example, when the information representation is the company registration date 321 of the atypycal document 300 illustrated as an example in FIG. 3, the word “Registration” is substituted for [Word] of the “Template Code” 530, “in same_line” is substituted for the [Position], and “date” is substituted for C to generate the information representation pattern 400 illustrated in FIG. 4. Note that the function (Position) is a function that returns a function for obtaining a word group based on a parameter “Position”. In the case of FIG. 5, the parameter “Position” is replaced by “in same_line” meaning the same line, and the function (Position) thereby returns the function “same_line_word” 420 illustrated in FIG. 4.

FIG. 6 illustrates an example of the information representation template table 113. The information representation template table 113 illustrated as an example is formed of multiple entries (records) each including a line number 1131, a grammar representation element 1132, an information representation grammar 1133, and a support information type 1134. One entry of the information representation template table 113 corresponds to one information representation grammar.

An identifier (line number) assigned to each entry of the information representation template table 113 is stored in the line number 1131 among the above items.

The aforementioned grammar representation elements of the information representation grammar are stored in the grammar representation element 1132.

Contents in which the information representation grammar is represented in a predetermined notation method (for example, a notation method based on a notation method of natural language grammar) are stored in the information representation grammar 1133.

A support information type, a category of the support information used in extraction of the extraction target from the information representation based on the structure of the information representation, is set in the support information type 1134. The information representation templates used for the generation of the information representation pattern are further finely categorized using the support information type, in addition to distinction based on the information representation grammar. In the present example, “regular expression”, “dictionary match”, “meta information (page number and the like)”, “HTML structure”, “set”, and “structure” are illustrated as examples of the support information type. Categorizing the information representation templates based on the support information types illustrated as an example enables comprehensive handling of atypycal documents of various formats.

FIG. 6 illustrates nine information representation grammars, distinguished by line numbers #1 to #9.

The information representation grammar 1133 “C is the [Same] as [Words].” of the line number “#1” among these information representation grammars has such contents that “C (information extraction target) has the same meaning [Same] as predetermined information (word) or information group (word group) [Words]”. “C[S] [W]” indicating the grammar representation elements of this information representation grammar is stored in the grammar representation element 1132 of this line. Using the information representation grammar representing a meaning relation between the extraction target and the predetermined information or a predetermined information group as one of the categories as described above enables efficient identification of a suitable information representation template.

Identifiers “Template 1” to “Template 4” of the information representation templates are stored in “regular expression”, “dictionary match”, “meta information”, and “HTML structure” in the support information type 1134 of this line, respectively.

A template of a program code that determines whether the representation of C (information extraction target) matches the regular expression or not is described in the information representation template “Template 1” stored in the support information type “regular expression”. For example, in the case of the atypycal document 300 of FIG. 1, the above program code determines whether three numerical values divided by slashes such as “numerical value/numerical value/numerical value” matches the regular expression or not, for date “07/16/2007” that is C (information extraction target).

A template of a program code that determines whether or not C (information extraction target) matches a word included in a dictionary set by the user or the like is described in the information representation template “Template 2” stored in the support information type “dictionary match”. For example, in the case of the atypycal document 300 of FIG. 1, the above program code determines whether or not a company name of “AAA Company” matches a word included in a name list of company names that is the dictionary.

A template of a program code that determines whether or not C (information extraction target) matches a character string which is not expressed as a character string on the document and which is included in, for example, the total page number, a creator of a computerized document, a creation date, and the like is described in the information representation template “Template 3” stored in the support information type “meta information”. For example, in the case of the atypycal document 300 of FIG. 1, when C (information extraction target) is the date “07/16/2007” present in the last page among multiple pages, the above program code determines whether or not the total number of pages of the document matches the page number in which the date “07/16/2007” is present.

A template of a program code that determines whether or not a control character for displaying C (information extraction target) matches a specific control character when the atypycal document is a document such as HTML formatted by being embedded with a control character is described in the information representation template “Template 4” stored in the support information type “HTML structure”. For example, when the atypycal document 300 of FIG. 1 is described in HTML and C (information extraction target) is the application date “09/22/2010” present in the header 310, the above program code determines whether or not the date to which <header> tag of HTML is assigned as the control character matches C (information extraction target).

The information representation grammar 1133 “C is the [Position] of [Ranges].” of the line number “#2” has such contents that “position [Position] of C (information extraction target) belongs to a region or a region group [Ranges]”. “C[P] [R]” indicating the grammar representation elements of this information representation grammar is stored in the grammar representation element 1132 of this line. Using the information representation grammar representing the relation between the position of the extraction target and the region or the region group as one of the categories as described above enables efficient identification of a suitable information representation template.

Identifiers “Template 5” to “Template 7” of the information representation templates are stored in “HTML structure”, “set”, and “structure” in the support information type 1134 of this line, respectively.

Assuming that the document is a document such as HTML formatted by being embedded with control characters, a template of a program code that determines whether or not C (information extraction target) is present in a specific positional relation [Position] with a region group [Ranges] represented in HTML is described in the information representation template “Template 5” stored in the support information type “HTML structure”. For example, when the atypycal document 300 of FIG. 1 is a document described in HTML, the above program code determines whether or not C (information extraction target) that is the date “07/16/2007” present below the header 310 is present after the end position of the <header> tag of HTML.

A template of a program code that determines whether or not C (information extraction target) is present in a specific positional relation [Position] with a region group [Ranges] is described in the information representation template “Template 6” stored in the support information type “set”. For example, when C (information extraction target) is the date “07/16/2007” near the center of the body 320 of the atypycal document 300 in FIG. 1, for example, the above program code determines whether or not the date being the target is present in, for example, a range between an upper 20% region and a lower 20% region of the body 320.

A template of a program code that determines whether or not C (information extraction target) is present in a specific positional relation [Position] with one of regions in a region group [Ranges] is described in the information representation template “Template 7” stored in the support information type “structure”. For example, when C (information extraction target) is the application date “09/22/2010” present in an upper portion of the atypycal document 300 in FIG. 1, for example, the above program code determines whether or not the date being the target is present in a range of upper 10% of the atypycal document 300.

The information representation grammar 1133 “C is the [Position] of [Words].” of the line number “#3” has such contents that “position [Position] of C (information extraction target) has a predetermined positional relation with predetermined information (word) or information group (word group) [Words]”. “C[P] [W]” indicating the grammar representation elements of this information representation grammar is stored in the grammar representation element 1132 of this line. Using the information representation grammar representing the positional relation between the position of the extraction target and the predetermined information or a predetermined information group as one of the categories enables efficient identification of a suitable information representation template.

Identifiers “Template 8” to “Template 10” of the information representation templates are stored in “HTML structure”, “set”, and “structure” in the support information type 1134 of this line, respectively. Note that these information representation templates are the information representation templates of “Template 5” to “Template 7” in the line number “#2” in which the region group [Ranges] is substituted by the word group [Words], respectively.

A template of a program code that determines whether or not a word “Year” is present in a <td> tag present in the same row as C (information extraction target), for example, when C (information extraction target) is the fiscal year “2007” in the atypycal document 300 in FIG. 1 is described in the information representation template “Template 8” stored in the support information type “HTML structure”.

The information representation grammar 1133 “C is the [Relation] of [Words]” of the line number “#4” has such contents that “C (information extraction target) has a predetermined relation [Relation] with predetermined information (word) or information group (word group) [Words]. “C[R] [W]” indicating the grammar representation elements of the information representation grammar is stored in the grammar representation element 1132 of this line. Using the information representation grammar representing the relation between the position of the extraction target and the predetermined information or a predetermined information group as one of the categories as described above enables efficient identification of a suitable information representation template.

An identifier “Template 11” of an information representation template is stored in “set” in the support information type 1134 of this line. This information representation template determines whether or not C (information extraction target) has a predetermined relation [Relation] with a word group [Words]. In this case, the relation [Relation] means, for example, a relation identified by a comparison operation such as “equal”, “larger”, “smaller”, “largest”, “smallest”, or the like. For example, a template of a program code that determines whether or not “2009” is the latest (largest) or not among “2007”, “2008”, and “2009” that are present in the same row as the word “Year” when C (information extraction target) is the latest fiscal year “2009” in the atypycal document 300 in FIG. 1 is described in the information representation template.

The information representation grammars of the line numbers “#5” to “#9” are each a case where the information representation grammar includes multiple C (information extraction targets).

The information representation grammar 1133 “C is the [Position] of [Words (C)].” of the line number “#5” has such contents that “a position [Position] of first C (information extraction target) is in a predetermined positional relation with information (word) or information group (word group) [Words] that is second C (information extraction target)”. “C[P] [C]” indicating the grammar representation elements of the information representation grammar is stored in the grammar representation element 1132 of this line. Using the information representation grammar representing the positional relation between the first extraction target and the second extraction target as one of the categories as described above enables efficient identification of a suitable information representation template.

Identifiers “Template 12” to “Template 14” of the information representation templates are stored in “HTML structure”, “set”, and “structure” in the support information type 1134 of this line, respectively.

A template of a program code that determines whether or not first C (information extraction target) is present in a specific positional relation [Position] with second C (information extraction target) being a combination target is described in the information representation template “Template 12” stored in the support information type “HTML structure”, assuming that the document is a document formatted by being embedded with control characters such as HTML. For example, when the atypycal document 300 of FIG. 1 is described in HTML and first C (information extraction target) and second C (information extraction target) are, for example, “2007” and “$100,000”, respectively, the above program code determines whether or not first and second C (information extraction targets) are respectively in adjacent <td> tags of HTML to extract sales information of each fiscal year.

A template of a program code that determines whether or not first C (information extraction target) is present in a specific positional relation [Position] with a word group [Words] including second C (information extraction target) is described in the information representation template “Template 13” stored in the support information type “set”. For example, assume a case where information is extracted to calculate an average value of net profits from the atypycal document 300 of FIG. 1. In this case, for example, when first C (information extraction target) is “Net Profit” and second C (information extraction target) is one of “$10,000”, “$30,000”, and “$30,000”, the above program code determines whether first and second C (information extraction targets) are present in the same row.

The information representation grammar 1133 “C & C is the [Position] of [Ranges].” of the line number “#6” has such contents that “positions [Position] of first C (information extraction target) and second C (information extraction target) both belong to a predetermined region or region group [Ranges]”. “CC[R] [W]” indicating the grammar representation elements of this information representation grammar is stored in the grammar representation element 1132 of this line. Using the information representation grammar representing the relation between the respective positions of the first extraction target and the second extraction target and the predetermined region or region as one of the categories as described above enables efficient identification of a suitable information representation template.

Identifiers “Template 15” to “Template 17” of the information representation templates are stored in “HTML structure”, “set”, and “structure” in the support information type 1134 of this line, respectively.

A template of a program code that identifies whether or not first C (information extraction target) and second C (information extraction target) are present in a specific positional relation [Position] with one of region groups [Ranges] is described in the information representation template “Template 15” stored in the support information type “HTML structure”, assuming that the document is a document formatted by embedding control characters such as HTML. For example, when the atypycal document 300 of FIG. 1 is described in HTML and first C (information extraction target) and second C (information extraction target) are “2007” and “$100,000”, respectively, for example, the above program code determines whether or not first and second C (information extraction targets) are both included in the same <tr> tag of HTML to extract sales of each fiscal year.

A template of a program code that determines whether or not first C (information extraction target) and second C (information extraction target) are in a specific positional relation [Position] with a region group [Ranges] is described in the information representation template “Template 16” stored in the support information type “set”. For example, when first C (information extraction target) is “2007” and second C (information extraction target) is “$100,000” in the atypycal document 300 of FIG. 1, for example, the above program code identifies whether or not first and second C (information extraction targets) are included in a region in which row names are described in the atypycal document 300 and a region of a first row in which serial numbers are assigned.

A template of a program code that determines whether or not first C (information extraction target) and second C (information extraction target) are in a specific positional relation [Position] with one of region groups [Ranges] is described in the information representation template “Template 17” stored in the support information type “structure”. For example, when first C (information extraction target) is “2007” and second C (information extraction target) is “$100,000” in the atypycal document 300 of FIG. 1, for example, the above program code determines whether or not first and second C (information extraction targets) are both present below a region in which the row names are described in the atypycal document 300.

The information representation grammar 1133 “C & C is the [Position] of [Words].” of the line number “#7” has such contents that “positions [Position] of first C (information extraction target) and second C (information extraction target) each have a specific positional relation with predetermined information (word) or information group (word group) [Words]”. “CC[P] [W]” indicating the grammar representation elements of this information representation grammar is stored in the grammar representation element 1132 of this line. Using the information representation grammar representing the positional relation between the position of each of the first extraction target and the second extraction target and the predetermined information or a predetermined information group as one of the categories as described above enables efficient determination of a suitable information representation template.

Identifiers “Template 18” to “Template 20” of the information representation templates are stored in “HTML structure”, “set”, and “structure” in the support information type 1134 of this line, respectively. These information representation templates “Template 18” to “Template 20” are the information representation templates of “Template 15” to “Template 17” in the line number “#6” in which the region group [Ranges] is substituted by the word group [Words], respectively.

For example, a template of a program code that determines whether or not first C (information extraction target) and second C (information extraction target) are present in a specific positional relation [Position] with one of word groups [Words] is described in the information representation template “Template 18” stored in the support information type “HTML structure”. For example, when the atypycal document 300 of FIG. 1 is described in HTML and first C (information extraction target) and second C (information extraction target) are “2007” and “$100,000”, respectively, the above program code determines whether or not first and second C (information extraction targets) are present in the same row as the serial number “1”.

The information representation grammar 1133 “C is the [Relation] of C.” of the line number “#8” has such contents that “first C (information extraction target) and second C (information extraction target) has a predetermined relation [Relation]”. “C[R]C” indicating the grammar representation elements of this information representation grammar is stored in the grammar representation element 1132 of this line. In this case, the relation [Relation] means, for example, a relation identified by a comparison operation such as “equal”, “larger”, “smaller”, “largest”, “smallest”, or the like. Using the information representation grammar representing the relation between the first extraction target and the second extraction target as one of the categories as described above enables efficient identification of a suitable information representation template.

An identifier “Template 21” of an information representation template is stored in “set” of the support information type 1134 of this line. A template of a program code that determines whether first C (information extraction target) and second C (information extraction target) has a specific relation [Relation] is described in the information representation template “Template 21”. For example, assume a case where a combination of sales and net profit is to be extracted from the atypycal document 300 of FIG. 1. In this case, when first C (information extraction target) is “$100,000” and second C (information extraction target) is “$100,000” for the sales and net profit of the fiscal year 2007, for example, the above program code determines that C (information extraction target) which is larger as a numerical value is the sales and C (information extraction target) which is smaller is the net profit.

The information representation grammar 1133 “C & C is the [Relation] of [Words].” of the line number “#9” has such contents that “first C (information extraction target) and second C (information extraction target) have a predetermined relation [Relation] with predetermined information (word) or information group (word group) [Words]”. “CC[R] [W]” indicating the grammar representation elements of this information representation grammar is stored in the grammar representation element 1132 of this line. In this case, the relation [Relation] means, for example, a relation identified by a comparison operation such as “equal”, “larger”, “smaller”, “largest”, “smallest”, or the like. Using the information representation grammar representing the relation of the first extraction target and the second extraction target with predetermined information or a predetermined information group as one of the categories as described above enables efficient identification of a suitable information representation template.

An identifier “Template 22” of an information representation template is stored in “set” in the support information type 1134 of this line. A template of a program code that determines whether or not first C (information extraction target) and second C (information extraction target) have a specific relation [Relation] with a specific word group [Words] is described in the information representation template “Template 22”. For example, assume a case where a combination of sales and net profit is to be extracted from the atypycal document 300 of FIG. 1. In this case, when first C (information extraction target) is “$100,000” and second C (information extraction target) is “$100,000” for the sales and net profit of the fiscal year 2007, for example, the above program code determines whether or not first and second C (information extraction target) are both large by comparing the number of digits of each C (information extraction target) with the number of digits of the numerical value of each of the serial number and the fiscal year to separate C (information extraction targets) from the numerical values of the serial number and the fiscal year.

Note that identifying the information representation template using the nine information representation grammars (lines #1 to #9) illustrated in the information representation template table 113 allows the information representation template to be suitably identified while comprehensively covering various atypycal documents. Performing pattern matching of the atypycal documents by executing the information representation pattern generated with the information representation template specified from the information representation template table 113 using the information representation grammar and the support information type allows information targeted by the user to be accurately extracted from various atypycal documents.

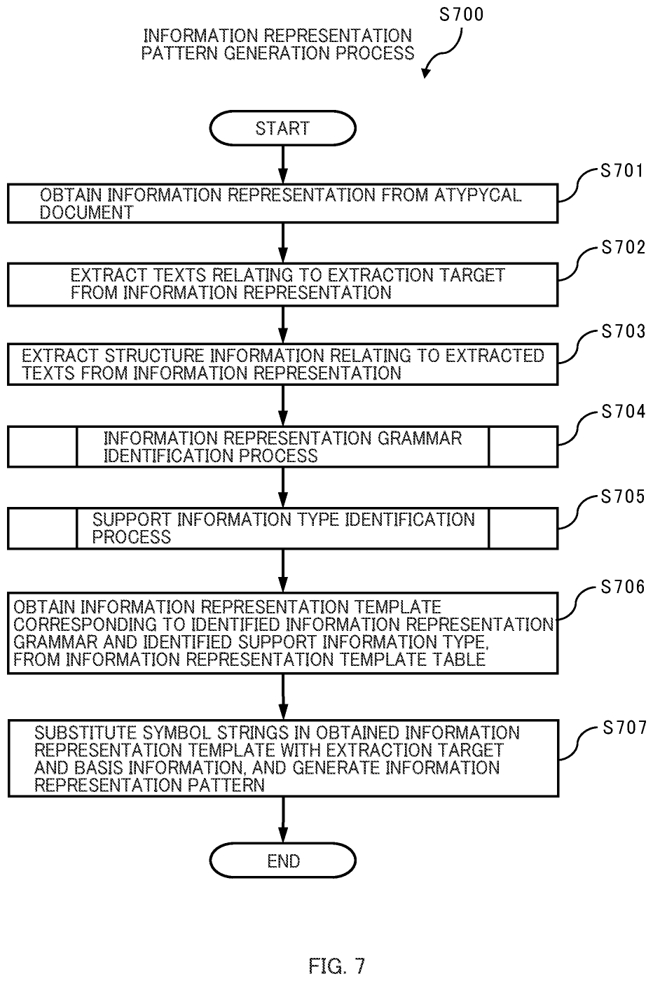

FIG. 7 is a flowchart explaining a process (hereinafter, referred to as “information representation pattern generation process S700”) in which the information representation structure analysis part 120 analyzes the information representation included in the atypycal document and the information representation pattern generation part 130 generates the information representation pattern using the result of the analysis. The information representation pattern generation process S700 is described below together with FIG. 7.

First, the information representation structure analysis part 120 obtains the information representation from the atypycal document, and registers the information representation in the information representation group 111 (S701). For example, when the atypycal document is the atypycal document 300 illustrated as an example in FIG. 3, the information representation structure analysis part 120 obtains, for example, a region of the company registration date 321 (region including “Registration” and the date “07/16/2007”) as the information representation. For example, objects included in a range specified by the user via the user device 3 may be obtained as the information representation.

Next, the text information extraction part 121 extracts texts relating to the extraction target, from the information representation obtained in S701 (S702). For example, when the information representation is the company registration date 321 obtained from the atypycal document 300 illustrated as an example in FIG. 3 and the extraction target is “07/16/2007”, the text information extraction part 121 extracts “Registration” and “07/16/2007” as the texts.

Next, the structure information extraction part 122 extracts the structure information relating to the texts extracted in S702 from the information representation obtained in S701 (S703). For example, when the information representation is the company registration date 321 obtained from the atypycal document 300 illustrated as an example in FIG. 3 that is the atypycal document, the structure information extraction part 122 extracts coordinates of a region surrounding each of the character strings of the text “registration” and the text “07/16/2007” extracted in S702 as the structure information. The aforementioned coordinates are expressed by, for example, a set of coordinates of an upper left corner (xs, ys) and coordinates of a lower right corner (xe, ye) of the region surrounding each character string.

Next, the information representation grammar identification part 123 identifies the information representation grammar 1133 corresponding to the extracted texts and structure information, from the information representation template table 113 (S704). Note that details of this process (hereinafter, referred to as “information representation grammar identification process S704”) are described later.

Next, the support information type identification part 124 identifies the support information type corresponding to the extracted texts and structure information from the support information type 1134 of the information representation template table 113 (S705). Note that details of this process (hereinafter, referred to as “support information type identification process S705”) are described later.

Next, the information representation template retrieval part 131 of the information representation pattern generation part 130 obtains the information representation template corresponding to a combination of the information representation grammar identified in S703 and the support information type identified in S704 from the information representation template table 113 (S706).

Next, the information representation component element substitution part 132 of the information representation pattern generation part 130 substitutes bracketed notations in the information representation template obtained in S706 with the extraction target and the basis information and generates the information representation pattern (S707).

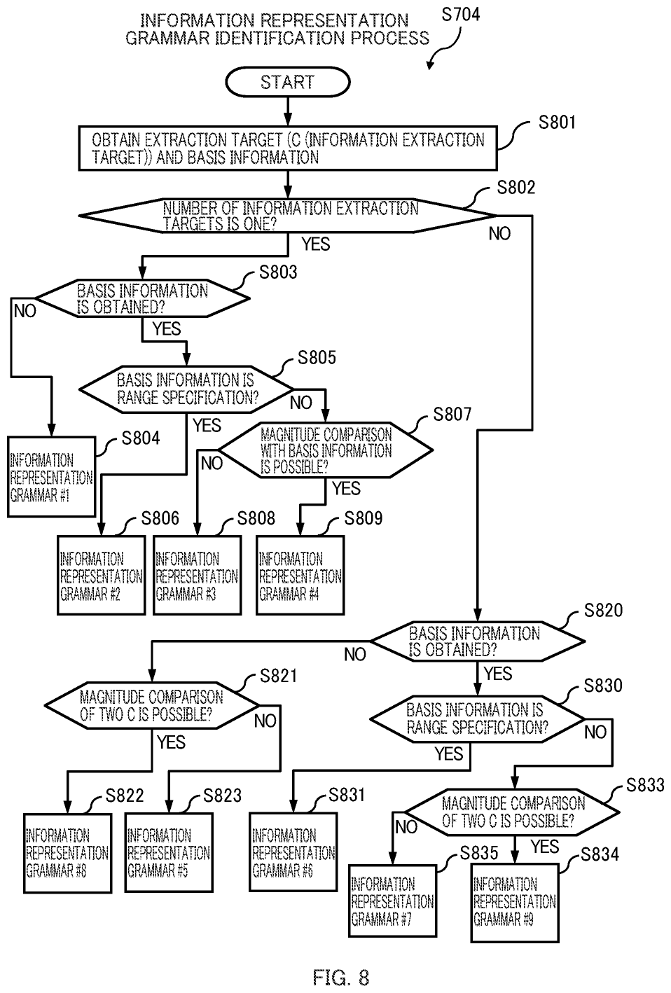

FIG. 8 is a flowchart explaining details of the information representation grammar identification process S704 illustrated in FIG. 7. The information representation grammar identification process S704 is described below together with FIG. 8. Note that a description is given of the case where the information representation grammars 1133 in the information representation template table 113 illustrated as an example in FIG. 6 to which the information representation obtained in S701 of FIG. 7 (hereinafter, referred to as “this information representation”) corresponds is identified as an example.

The information representation grammar identification part 123 first obtains information (one or more C (information extraction targets)) intended to be extracted from this information representation and information (hereinafter, referred to as “basis information”) to be used for determination of whether an object is the extraction target or not (S801). Note that the basis information does not always have to be obtained. For example, the information representation grammar identification part 123 may receive these pieces of information from the user via the user device 3. For example, regarding C (information extraction target), display on a display device is performed, and the user specifies a target word by clicking on the target word with a mouse. Moreover, regarding the basis information, display on the display device is similarly performed, and the user clicks on the target word or specifies a range of a target region with the mouse. Note that, when the basis information is invisible, for example, the user clicks on only C (information extraction target).

Next, the information representation grammar identification part 123 determines whether the number of C (information extraction targets) obtained in S801 is one or two or more (S802). When there is one C (information extraction target) (S802: YES), the processing proceeds to S803. When there are multiple Cs (information extraction targets), the processing proceeds to S820.

In S803, the information representation grammar identification part 123 determines whether there is basis information. When no basis information is obtained in S801 (S803: NO), the processing proceeds to S804. When the basis information is obtained in S801 (S803: YES), the processing proceeds to S805.

In S804, the information representation grammar identification part 123 assumes that the basis information is invisible document information (regular expression, dictionary match, meta information, control characters such as an HTML tag, or the like), and determines that this information representation corresponds to the information representation grammar of the line number “#1” in the information representation template table 113. Then, the information representation grammar identification process S704 is terminated.

In S805, the information representation grammar identification part 123 determines whether or not the basis information is a range specification (S805). When the basis information is the range specification (S805: YES), the processing proceeds to S806, and the information representation grammar identification part 123 determines that this information representation corresponds to the information representation grammar of the line number “#2” in the information representation template table 113. Then, the information representation grammar identification process S704 is terminated. When the basis information is not the range specification (S805: NO), the processing proceeds to S807.

In S807, the information representation grammar identification part 123 determines whether or not the basis information is an information (word) or information group (word group) whose magnitude cannot be compared with that of C (information extraction target) in the information representation. When the basis information is an information (word) or information group (word group) whose magnitude cannot be compared (S807: NO), the processing proceeds to S808, and the information representation grammar identification part 123 determines that this information representation corresponds to the information representation grammar of the line number “#3” in the information representation template table 113. Then, the information representation grammar identification process S704 is terminated. Conversely, when the basis information is an information (word) or information group (word group) whose magnitude can be compared (S807: YES), the processing proceeds to S809, and the information representation grammar identification part 123 determines that this information representation corresponds to the information representation grammar of the line number “#4” in the information representation template table 113. Then, the information representation grammar identification process S704 is terminated.

In S820, the information representation grammar identification part 123 determines whether there is basis information. When no basis information is obtained (S820: NO), the processing proceeds to S821. When the basis information is obtained (S820: YES), the processing proceeds to S830.

In S821, the information representation grammar identification part 123 determines whether or not C (information extraction targets) are numerical values or the like and a magnitude comparison thereof is possible. When C (information extraction targets) are numerical value or the like and the magnitude comparison thereof is possible (S821: YES), the processing proceeds to S822, and the information representation grammar identification part 123 determines that this information representation corresponds to the information representation grammar of the line number “#8” in the information representation template table 113. Then, the information representation grammar identification process S704 is terminated. Conversely, when a magnitude comparison is not possible (S821: NO), the processing proceeds to S823, and the information representation grammar identification part 123 determines that this information representation corresponds to the information representation grammar of the line number “#5” in the information representation template table 113. Then, the information representation grammar identification process S704 is terminated.

In S830, the information representation grammar identification part 123 determines whether the basis information is a range specification. When the basis information is the range specification (S830: YES), the processing proceeds to S831 and the information representation grammar identification part 123 determines that this information representation corresponds to the information representation grammar of the line number “#6” in the information representation template table 113. Then, the information representation grammar identification process S704 is terminated. Conversely, when the basis information is not a range specification (S830: NO), the processing proceeds to S833.

In S833, the information representation grammar identification part 123 determines whether or not C (information extraction target) is a numerical value or the like and a magnitude comparison thereof is possible. When C (information extraction target) is a numerical value or the like and the magnitude comparison thereof is possible (S833: YES), the processing proceeds to S834, and the information representation grammar identification part 123 determines that this information representation corresponds to the information representation grammar of the line number “#9” in the information representation template table 113. Then, the information representation grammar identification process S704 is terminated. Conversely, when a magnitude comparison is not possible (S833: NO), the processing proceeds to S835, and the information representation grammar identification part 123 determines that this information representation corresponds to the information representation grammar of the line number “#7” in the information representation template table 113. Then, the information representation grammar identification process S704 is terminated.

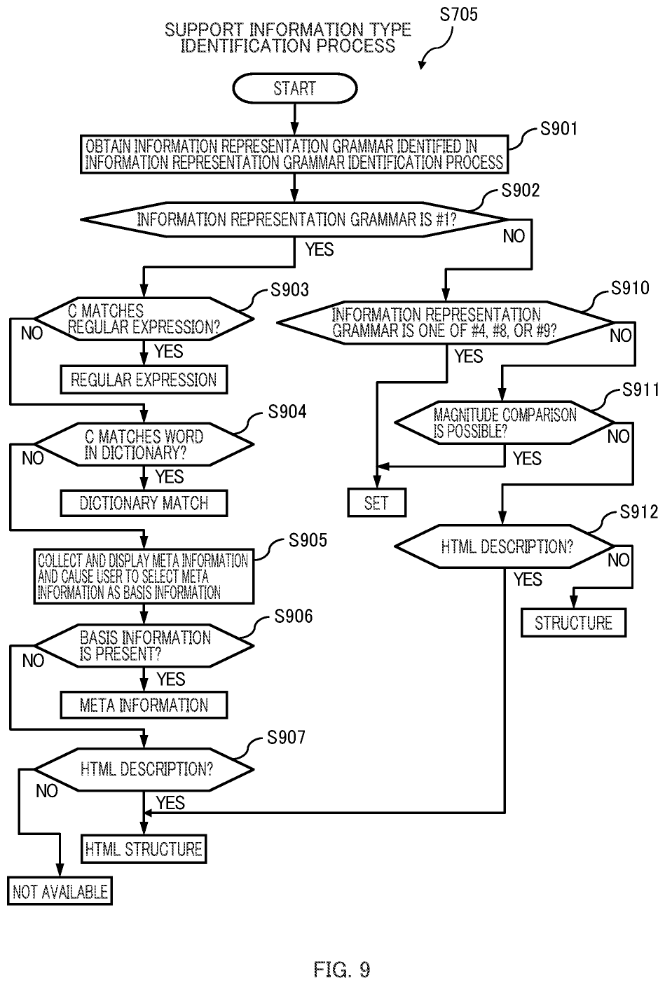

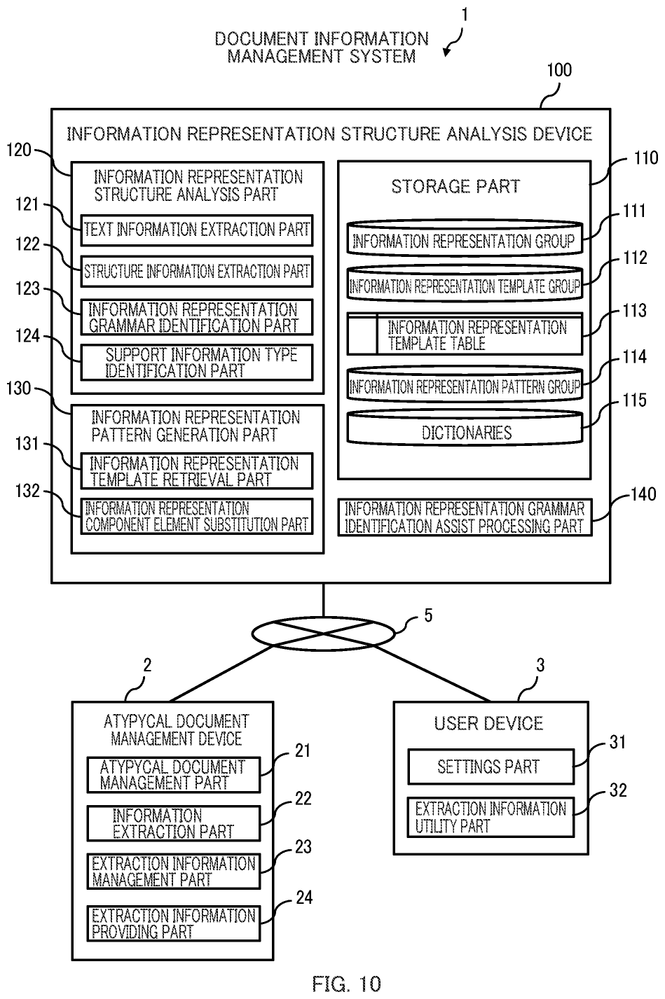

FIG. 9 is a flowchart explaining the details of the support information type identification process S705 illustrated in FIG. 7. The support information type identification process S705 is described below together with FIG. 9. Note that a description is given of the case where the support information types 1134 in the information representation template table 113 illustrated as an example in FIG. 6 to which the information representation obtained in S701 of FIG. 7 (hereinafter, referred to as “this information representation”) corresponds is identified as an example.

First, the support information type identification part 124 obtains the information representation grammar identified in the information representation grammar identification process S704 (S901).

Next, the support information type identification part 124 determines whether or not the obtained information representation grammar is the information representation grammar of the line number “#1” (S902). When the obtained information representation grammar is the information representation grammar of the line number “#1” (S902: YES), the processing proceeds to S903. When the obtained information representation grammar is not the information representation grammar of the line number “#1” (S902: NO), the processing proceeds to S910.

In S903, the support information type identification part 124 determines whether or not the support information type of this information representation is “regular expression”. Specifically, the support information type identification part 124 performs the above determination by reading a regular expression dictionary in the dictionaries 115 and determining whether or not C (information extraction target) matches a regular expression. When the support information type identification part 124 determines that the support information type of this information representation is “regular expression” (S903: YES), the support information type identification process S705 is terminated. Conversely, when the support information type identification part 124 determines that the support information type of this information representation is not “regular expression” (S903: NO), the processing proceeds to S904.

In S904, the support information type identification part 124 determines whether or not the support information type of this information representation corresponds to “dictionary match”. Specifically, the support information type identification part 124 performs the above determination by reading a word dictionary in the dictionaries 115 and determining whether or not there is a match with C (information extraction target). When the support information type identification part 124 determines that the support information type of this information representation is “dictionary match” as a result of the above determination (S904: YES), the support information type identification process S705 is terminated. Conversely, when the support information type identification part 124 determines that the support information type of this information representation is not “dictionary match” (S904: NO), the processing proceeds to S905.

Note that there is a case where the support information type of this information representation matches both of “regular expression” and “dictionary match”. In this case, it is possible to present this information to the user via the user device 3 and cause the user to select one of “regular expression” and “dictionary match”, or terminate the processing without narrowing down the candidate to either “regular expression” or “dictionary match”.

In S905, the support information type identification part 124 extracts the meta information from the atypycal document and presents the meta information to the user to cause the user to select whether the basis information is present. When the user determines that the basis information is present in the presented meta information (S905: YES), the support information type identification part 124 determines that the support information type of this information representation is “meta information” (page number or the like), and the support information type identification process S705 is terminated. Conversely, when the user determines that the basis information is absent in the presented meta information (S905: NO), the processing proceeds to S907.

In S907, the support information type identification part 124 determines whether or not the atypycal document in which the information representation is described is described in HTML. When the atypycal document is described in HTML (S907: YES), the support information type identification part 124 determines that the support information type of this information representation is “HTML structure”, and the support information type identification process S705 is terminated. Conversely, when the atypycal document is not described in HTML (S907: NO), the support information type identification part 124 determines that this information representation has no corresponding support information type (not available), and the support information type identification process S705 is terminated. Note that, in the case of a determination of not available, the support information type identification part 124 may cause the user to input a regular expression or dictionary information, and determine that the support information type of the information representation is “regular expression” or “dictionary match”.

In S910, the support information type identification part 124 determines whether or not the information representation grammar obtained in S901 matches one of the information representation grammars of the line numbers “#4”, “#8”, or “#9”. When the information representation grammar matches one of the information representation grammars (S910: YES), the support information type identification part 124 determines that the support information type of this information representation is “set”, and the support information type identification process S705 is terminated. When the information representation grammar matches none of the information representation grammars (S910: NO), the processing proceeds to S911.

In S911, the support information type identification part 124 determines whether or not C (information extraction target) and the basis information are numerical values or dates and a magnitude relationship comparison thereof is possible. When a magnitude relationship comparison is possible (S911: YES), the support information type identification part 124 determines that the support information type of this information representation is “set”, and the support information type identification process S705 is terminated. When a magnitude relationship comparison is not possible (S911: NO), the processing proceeds to S912.

In S912, the support information type identification part 124 determines whether or not the atypycal document in which the information representation is described is described in HTML. When the atypycal document is described in HTML (S912: YES), the support information type identification part 124 determines that the support information of this information representation is “HTML structure”, and the support information type identification process S705 is terminated. When the atypycal document is not described in HTML (S912: NO), the support information type identification part 124 determines that the support information is “structure”.

As described above, according to the document information management system 1 of the first embodiment, it is possible to analyze the structure of the information representation included in a atypycal document and generate the information representation pattern to be used in the extraction of information from the atypycal document. Moreover, the atypycal document management device 2 can efficiently extract information intended to be obtained by the user, from various atypycal documents with varying formats, using the generated information representation pattern.

### Second Embodiment

FIG. 10 illustrates a schematic configuration of a document information management system 1 illustrated as a second embodiment. In addition to the functions included in the information representation structure analysis device 100 of the first embodiment, the information representation structure analysis device 100 in the document information management system 1 of the second embodiment further includes an information representation grammar identification assist processing part 140.

The information representation grammar identification assist processing part 140 assists obtaining of information (C (information extraction target), basis information, and the like. Hereinafter, referred to as “identification assist information”) necessary for the information representation structure analysis part 120 to identify the information representation grammar.

Specifically, the information representation grammar identification assist processing part 140 presents a screen (hereinafter, referred to as “identification assist information obtaining screen 1200”) for receiving the above information via the user device 3 to the user, and obtains the above information from the user, via the identification assist information obtaining screen 1200. Presenting the identification assist information obtaining screen 1200 and guiding the user to input the necessary information as described above enables efficient obtaining of the identification assist information also when, for example, the user does not have sufficient knowledge or experience of generating the information representation pattern.

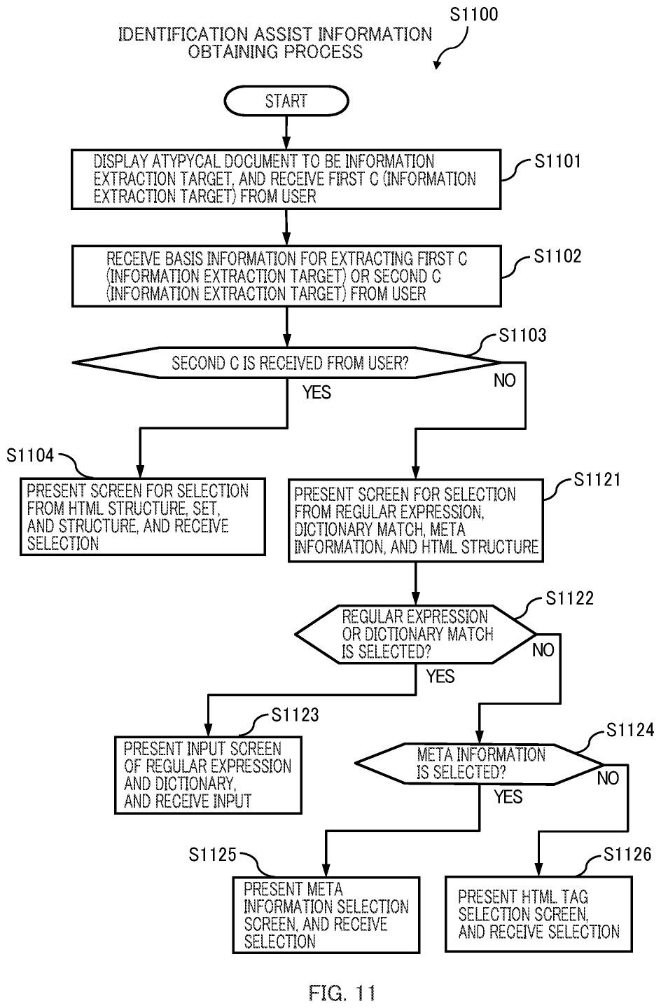

FIG. 11 is a flowchart explaining a process (hereinafter, referred to as “identification assist information obtaining process S1100”) performed when the information representation grammar identification assist processing part 140 presents the identification assist information obtaining screen 1200 to the user and obtains the identification assist information. The identification assist information obtaining process S1100 is described below together with FIG. 11.

First, the information representation grammar identification assist processing part 140 presents the identification assist information obtaining screen 1200 displaying the atypycal document to the user and receives specification of first C (information extraction target) from the user (S1101).

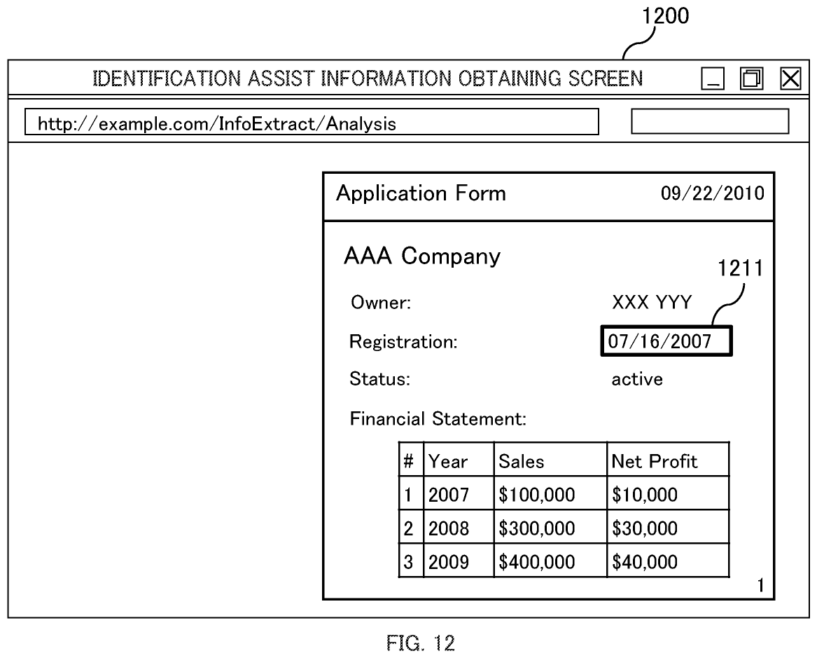

FIG. 12 illustrates an example of the identification assist information obtaining screen 1200 presented to the user in this case. In the example of FIG. 12, since the user has specified a date “07/16/2007” 1211 as first C (information extraction target), a corresponding region is displayed while being highlighted by a solid line frame.

Returning to FIG. 11, next, the information representation grammar identification assist processing part 140 receives specification of the basis information to be used for extraction of first C (information extraction target) or specification of second C (information extraction target), from the user (S1102).

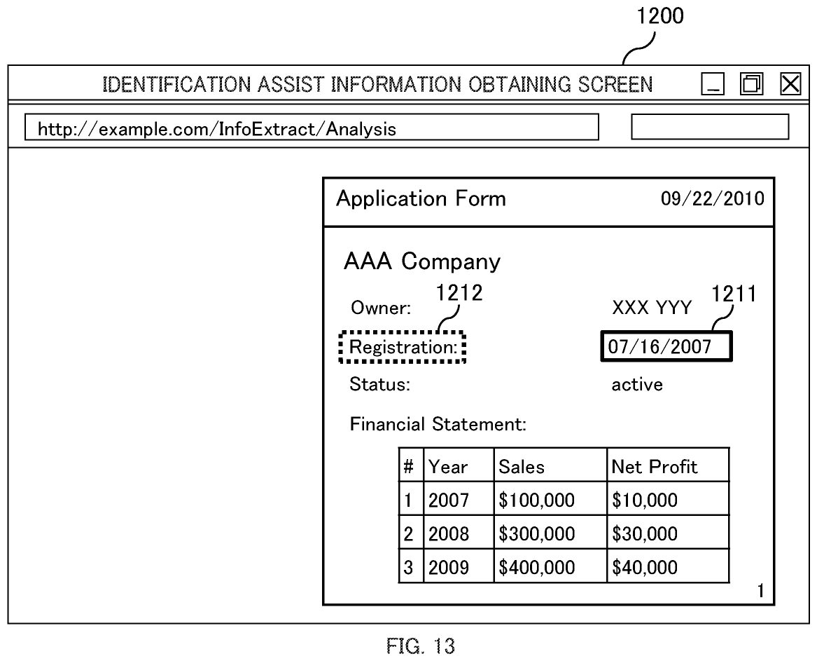

FIG. 13 illustrates an example of the identification assist information obtaining screen 1200 presented to the user in this case. In this example, since the user has specified a word “Registration” 1212 as the basis information, a corresponding region is displayed while being highlighted by a dotted line frame.

Returning to FIG. 11, next, the information representation grammar identification assist processing part 140 determines whether or not it has received the specification of second C (information extraction target) from the user in S1102 (S1103). When the information representation grammar identification assist processing part 140 has received the specification of second C (information extraction target) (S1103: YES), the processing proceeds to S1104. When the information representation grammar identification assist processing part 140 has not received the specification of second C (information extraction target) (S1103: NO), the processing proceeds to S1121.

In S1104, the information representation grammar identification assist processing part 140 receives selection of one of the support information types of “HTML structure”, “set”, and “structure” from the user via the identification assist information obtaining screen 1200.

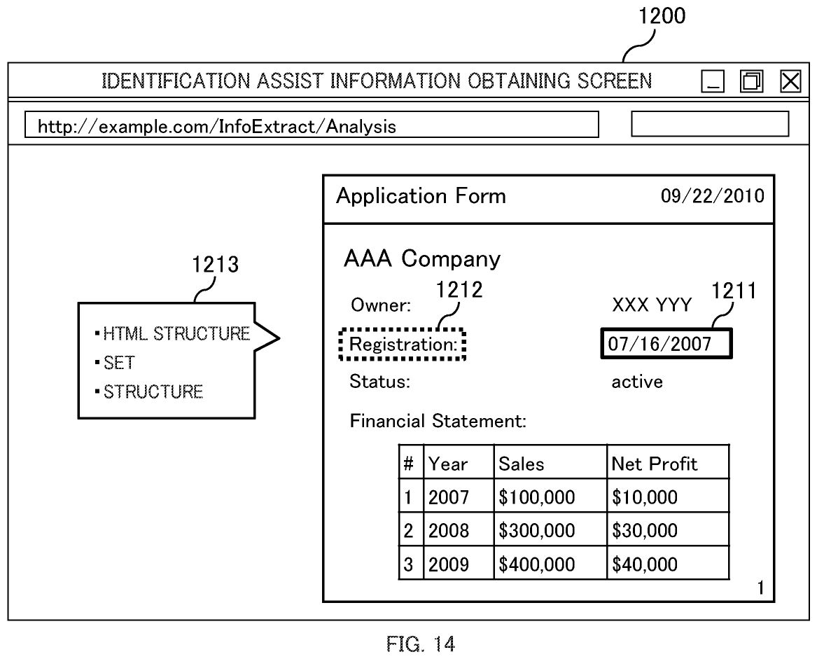

FIG. 14 illustrates an example of the identification assist information obtaining screen 1200 presented to the user in this case. In the example of FIG. 14, a selection field 1213 that receives selection of one of “HTML structure”, “set”, and “structure” is displayed in a left portion of the identification assist information obtaining screen 1200. Note that, as for reference of user selection, for example, the information representation pattern generated in the case where each of the support information types is selected may be presented to the user.

Then, the identification assist information obtaining process S1100 is terminated, and the information representation grammar identification assist processing part 140 identifies the information representation grammar from the information representation template table 113 using the received support information type.

Returning to FIG. 11, in S1121, the information representation grammar identification assist processing part 140 receives selection of one of the support information types of “regular expression”, “dictionary match”, “meta information”, and “HTML structure” from the user via the identification assist information obtaining screen 1200.

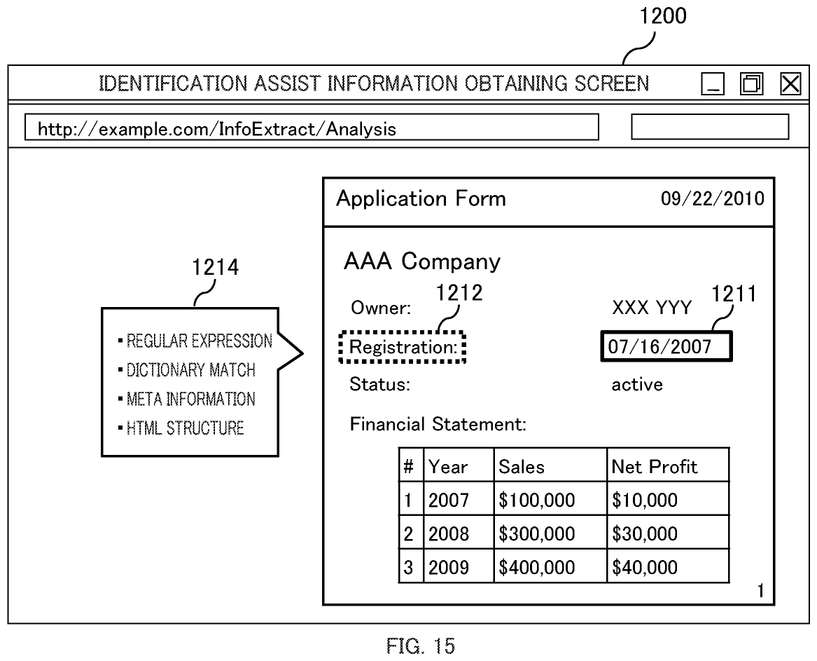

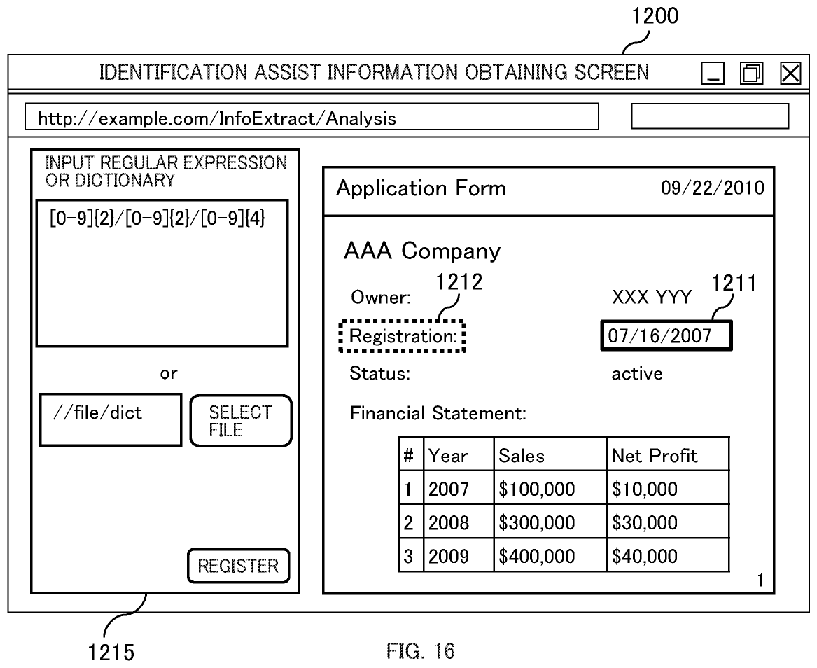

FIG. 15 illustrates an example of the identification assist information obtaining screen 1200 presented to the user in this case. In the example of FIG. 15, a selection field 1214 that receives selection of one of “regular expression”, “dictionary match”, “meta information”, and “HTML structure” is displayed in a left portion of the identification assist information obtaining screen 1200. Note that, as for reference of user selection, for example, the information representation pattern generated in the case where each of the support information types is selected may be presented to the user.

Returning to FIG. 11, next, the information representation grammar identification assist processing part 140 determines whether or not the user has selected “regular expression” or “dictionary match” in the identification assist information obtaining screen 1200 of FIG. 15 (S1122). When the user has selected “regular expression” or “dictionary match” (S1122: YES), the processing proceeds to S1123. When the user has not selected “regular expression” or “dictionary match” (S1122: NO), the processing proceeds to S1124.

In S1123, the information representation grammar identification assist processing part 140 receives an input of a regular expression or a dictionary from the user via the identification assist information obtaining screen 1200.

FIG. 16 illustrates an example of the identification assist information obtaining screen 1200 presented to the user in this case. In the example of FIG. 16, an input field 1215 that receives an input of a regular expression or a dictionary is displayed in a left portion of the identification assist information obtaining screen 1200.

Then, the identification assist information obtaining process S1100 is terminated, and the information representation grammar identification assist processing part 140 identifies the information representation grammar from the information representation template table 113 using contents of the received regular expression or dictionary.

Returning to FIG. 11, in S1124, the information representation grammar identification assist processing part 140 determines whether or not the user has selected “meta information” in the identification assist information obtaining screen 1200 of FIG. 15. When the user has selected “meta information” (S1124: YES), the processing proceeds to S1125. When the user has not selected “meta information” (S1124: NO), the processing proceeds to S1126.

In S1125, the information representation grammar identification assist processing part 140 receives specification of the meta information from the user via the identification assist information obtaining screen 1200.

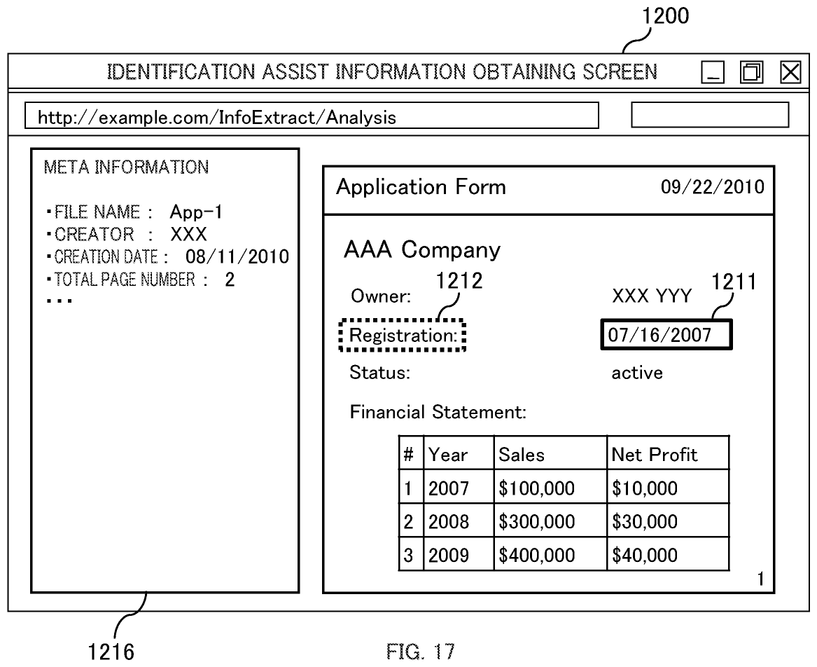

FIG. 17 illustrates an example of the identification assist information obtaining screen 1200 presented to the user in this case. In the example of FIG. 17, a selection field 1216 that receives selection of the meta information is displayed in a left portion of the identification assist information obtaining screen 1200.

Then, the identification assist information obtaining process S1100 is terminated, and the information representation grammar identification assist processing part 140 identifies the information representation grammar from the information representation template table 113 using the received meta information.

Returning to FIG. 11, in S1126, the information representation grammar identification assist processing part 140 receives specification of the HTML tag from the user via the identification assist information obtaining screen 1200.

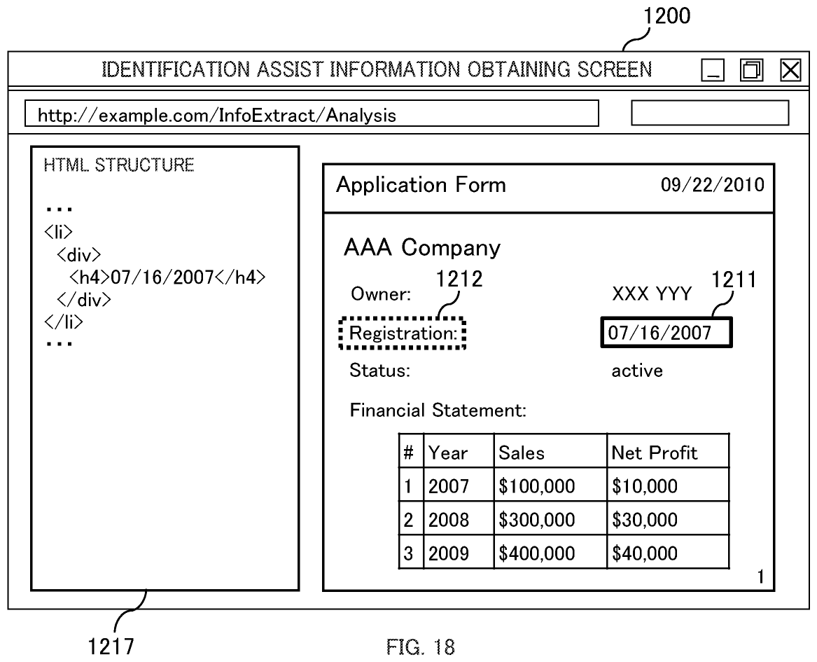

FIG. 18 illustrates an example of the identification assist information obtaining screen 1200 presented to the user in this case. In the example of FIG. 18, a selection field 1217 that receives selection of the HTML tag is displayed in a left portion of the identification assist information obtaining screen 1200.

Then, the identification assist information obtaining process S1100 is terminated, and the information representation grammar identification assist processing part 140 identifies the information representation grammar from the information representation template table 113 using the received HTML tag.

As described above, according to the document information management system 1 of the second embodiment, the identification assist information can be efficiently obtained from the user, and identifying the information representation grammar and the support information type using the identification assist information enables obtaining of a suitable information representation template and efficient generation of the information representation pattern.

### Third Embodiment

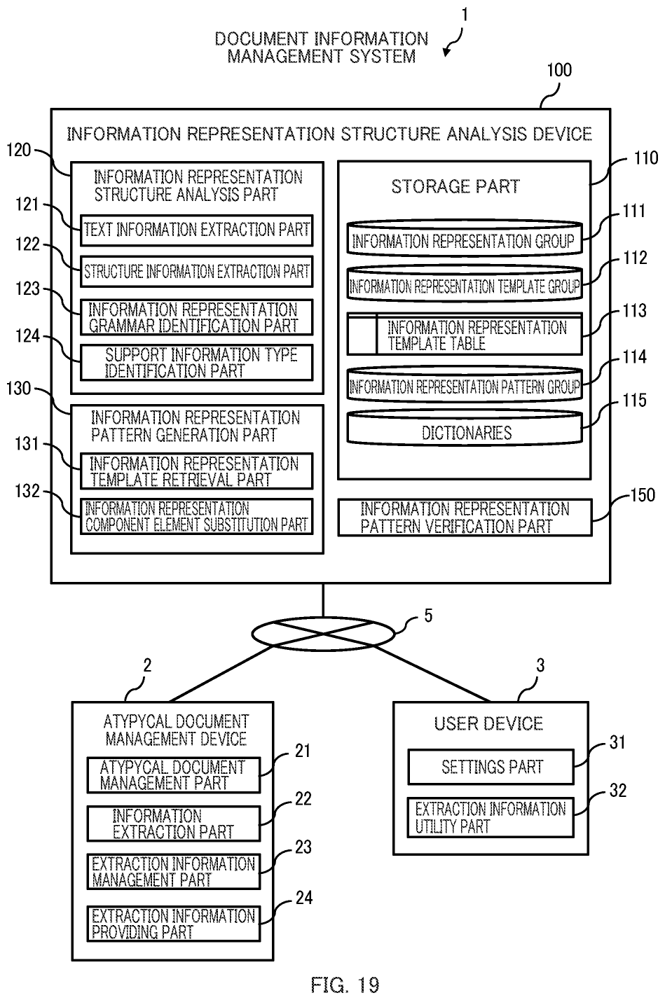

FIG. 19 illustrates a schematic configuration of a document information management system 1 in a third embodiment. In addition to the functions included in the information representation structure analysis device 100 in the first embodiment, the information representation structure analysis device 100 of the document information management system 1 in the third embodiment further includes an information representation pattern verification part 150.

The information representation pattern verification part 150 applies the information representation pattern generated by the information representation pattern generation part 130 to the atypycal document, and presents a result of this application to the user via the user device 3.

Using this function allows the user to verify whether or not the target information can be correctly extracted from the atypycal document using the information representation pattern generated by the information representation pattern generation part 130. Moreover, for example, when there are multiple pieces of target information, the user can verify whether each piece of information can be correctly extracted. Note that, when it is found that the target information cannot be extracted, for example, the user resets C (information extraction target) or the basis information and regenerates the information representation pattern.

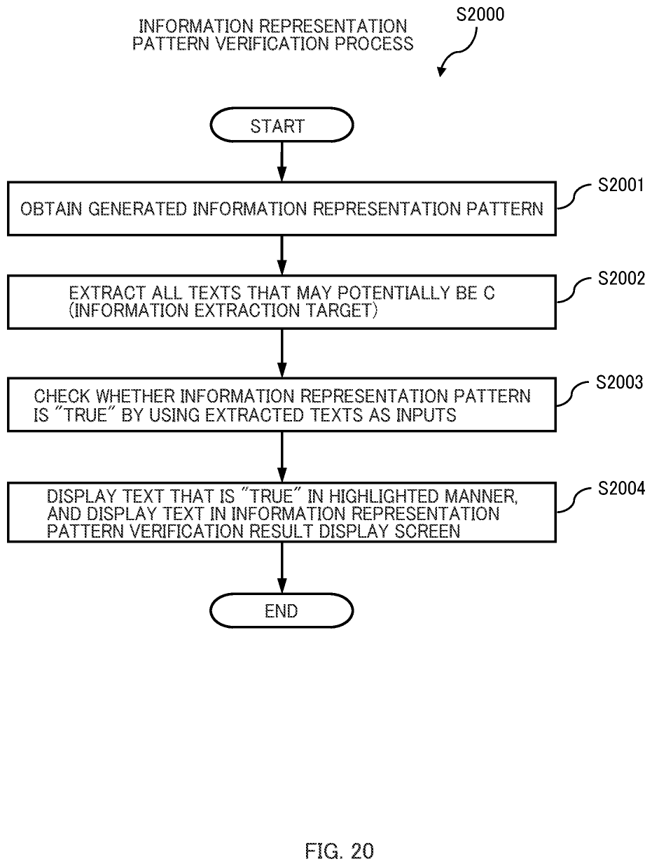

FIG. 20 is a flowchart for explaining a process (hereinafter, referred to as “information representation pattern verification process S2000”) performed when the information representation pattern verification part 150 verifies whether or not the extraction information can be correctly extracted from the atypycal document using the information representation pattern generated by the information representation pattern generation part 130. The information representation pattern verification process S2000 is described below together with FIG. 20.

First, the information representation pattern verification part 150 obtains the information representation pattern generated by the information representation pattern generation part 130 from the information representation pattern group 114 (S2001).

Then, the information representation pattern verification part 150 extracts all texts that may potentially be C (information extraction target) from a predetermined atypycal document (S2002).

Then, the information representation pattern verification part 150 inputs the texts extracted in S2002 into the information representation pattern obtained in S2001, and checks whether or not an execution result of the information representation pattern is “TRUE” (S2003).

Then, the information representation pattern verification part 150 generates a screen (hereinafter, referred to as “information representation pattern verification result display screen 2100”) in which a text that is “TRUE” is displayed while being highlighted together with the above atypycal document, and presents the information representation pattern verification result display screen 2100 to the user via the user device 3.

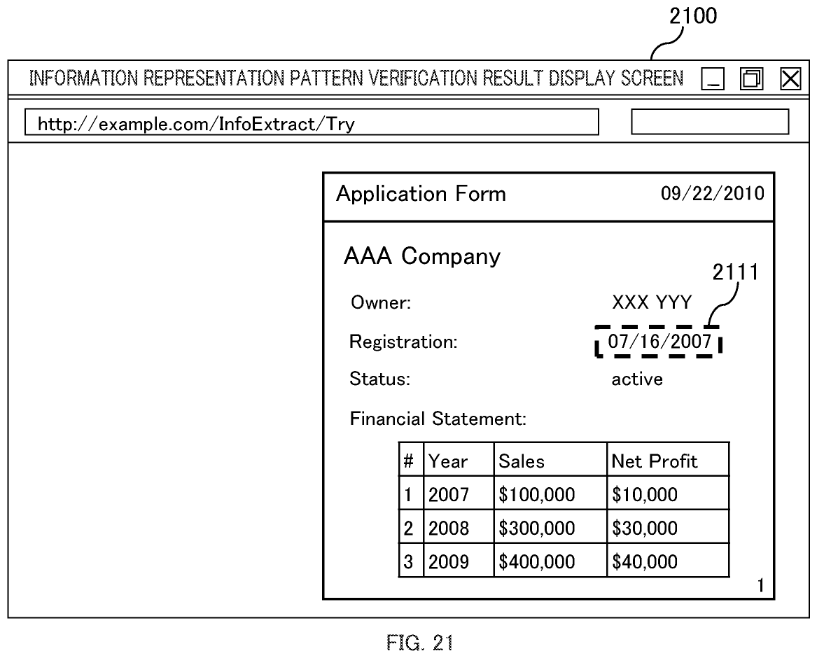

FIG. 21 illustrates the information representation pattern verification result display screen 2100. As illustrated in FIG. 21, in the illustrated information representation pattern verification result display screen 2100, the above atypycal document is displayed, and a text 2111 that is “TRUE” is displayed while being highlighted by a dotted line frame. The user can efficiently verify whether or not the information representation pattern correctly functions, by referring to the information representation pattern verification result display screen 2100.

Although one embodiment of the present invention has been described above, the present invention is not limited to the above embodiments, and various changes can be made within a scope not departing from the subject-matter of the present invention. For example, the above embodiments are described in detail to explain the present invention in an easily understandable manner, and are not necessarily limited to those including all the described configurations. Moreover, some of the configurations of the above embodiments may be deleted or replaced or other configurations may be added.

Furthermore, all or some of the configurations, function parts, processing parts, processing means, and the like described above may be implemented by hardware by, for example, being designed using integrated circuits or the like. Moreover, the above configurations, functions, and the like may be implemented by software by causing a processor to interpret and execute programs that implement the respective functions.

The information such as programs, tables, and files that implement the functions can be stored in a storage device such as a memory, a hard disk, or an SSD (solid state drive) or a storage medium such as an IC card, an SD card, or a DVD.

Moreover, an arrangement of the various function parts, the various processing parts, and the various databases in the various information processing devices described above is merely an example. The arrangement of the various function parts, the various processing parts, and the various databases may be changed to an arrangement that is optimal from the viewpoints of performance of hardware or software included in these devices, processing efficiency, communication efficiency, and the like.

Furthermore, the configuration (schema or the like) of the databases storing the various pieces of data described above can be flexibly changed from the viewpoints of efficient use of resources, an improvement in processing efficiency, an improvement in access efficiency, an improvement in retrieval efficiency, and the like.

### REFERENCE SIGNS LIST

1 document information management system
2 atypycal document management device
21 atypycal document management part
22 information extraction part
23 extraction information management part
24 extraction information providing part
3 user device
31 settings part
32 extraction information utility part
100 information representation structure analysis device
110 storage part
101 extraction target information
102 basis information group
111 information representation group
112 information representation template group
113 information representation template table
114 information representation pattern group
115 dictionaries
120 information representation structure analysis part
121 text information extraction part
122 structure information extraction part
123 information representation grammar identification part
124 support information type identification part
130 information representation pattern generation part
131 information representation template retrieval part
132 information representation component element substitution part
140 information representation grammar identification assist processing part
150 information representation pattern verification part
S700 information representation pattern generation process
S704 information representation grammar identification process
S705 support information type identification process
S1100 identification assist information obtaining process
1200 identification assist information obtaining screen
S2000 information representation pattern verification process
2100 information representation pattern verification result display screen

1. An information representation structure analysis device configured using an information processing device, the information representation structure analysis device comprising:
a storage part configured to store
an information representation being a mode of representation of information in a atypycal document,
an extraction target being information intended to be extracted from the information representation, and
basis information being information to be a basis in extraction of the extraction target from the information representation;
an information representation grammar identification part configured to identify an information representation grammar based on the extraction target and the basis information, the information representation grammar being a grammar describing the information representation to be an extraction source of the extraction target; and
a support information type identification part configured to identify a support information type of support information being information used in the extraction of the extraction target from the information representation, the support information type being a category of the support information based on a structure of the information representation, wherein
the storage part stores an information representation template for each combination of the information representation grammar and the support information type, the information representation template being a template used for generation of an information representation pattern being a program code for implementing a function of extracting the extraction target,
the information representation structure analysis device comprising:
an information representation template retrieval part configured to identify the information representation template to be used for the generation of the information representation pattern to be used for extraction of the extraction target from the atypycal document, based on the information representation grammar and the support information type identified for the information representation.

2. The information representation structure analysis device according to claim 1, wherein
the number of the extraction targets is one, and
the information representation grammar is a grammar representing that the extraction target has the same meaning as predetermined information or a predetermined information group.

3. The information representation structure analysis device according to claim 1, wherein
the number of the extraction targets is one, and
the information representation grammar is a grammar representing that a position where the extraction target is described is in a predetermined region or region group.

4. The information representation structure analysis device according to claim 1, wherein
the number of the extraction targets is one, and
the information representation grammar is a grammar representing that a position where the extraction target is described has a predetermined positional relation with predetermined information or a predetermined information group.

5. The information representation structure analysis device according to claim 1, wherein
the number of the extraction targets is one, and
the information representation grammar is a grammar representing that a position where the extraction target is described has a predetermined relation with predetermined information or a predetermined information group.

6. The information representation structure analysis device according to claim 1, wherein
the number of the extraction targets is two or more, and
the information representation grammar is a grammar representing that a position of a first of the extraction targets has a predetermined positional relation with information or information group being a second of the extraction targets.

7. The information representation structure analysis device according to claim 1, wherein
the number of the extraction targets is two or more, and
the information representation grammar is a grammar representing that the two or more extraction targets all belong to a predetermined region.

8. The information representation structure analysis device according to claim 1, wherein
the number of the extraction targets is two or more, and
the information representation grammar is a grammar representing that a position of each of the two or more extraction targets has a predetermined positional relation with predetermined information or a predetermined information group.

9. The information representation structure analysis device according to claim 1, wherein
the number of the extraction targets is two or more, and
the information representation grammar is a grammar representing that a first of the extraction targets has a predetermined relation with a second of the extraction targets.

10. The information representation structure analysis device according to claim 1, wherein
the number of the extraction targets is two or more, and
the information representation grammar is a grammar representing that a first of the extraction targets and a second of the extraction targets have a predetermined relation with predetermined information or a predetermined information group.

11. The information representation structure analysis device according to claim 1, wherein the support information type is at least one of a regular expression, a word dictionary, meta information, an HTML structure, a set of words, and a structure of the information representation.

12. The information representation structure analysis device according to claim 1, further comprising an information representation grammar identification assistance processing part configured to generate a screen for obtaining the extraction target and the basis information, present the screen to a user, and receive the extraction target and the basis information from the user via the screen, wherein
the storage part stores the extraction target and the basis information obtained by the information representation grammar identification assistance processing part.

13. The information representation structure analysis device according to claim 1, wherein the storage part stores the atypycal document,
the information representation structure analysis device further comprising an information representation pattern verification part configured to obtain the extraction target from the atypycal document by executing the information representation pattern generated by the information representation pattern generation part, generate a screen including the atypycal document and information indicating the extracted extraction target, and present the screen to a user.

14. An information representation structure analysis method of causing an information processing device to perform steps of:
storing an information representation being a mode of representation of information in a atypycal document, an extraction target being information intended to be extracted from the information representation, and basis information being information to be a basis in extraction of the extraction target from the information representation;
identifying an information representation grammar based on the extraction target and the basis information, the information representation grammar being a grammar describing the information representation to be an extraction source of the extraction target;
identifying a support information type of support information being information used in the extraction of the extraction target from the information representation, the support information type being a category of the support information based on a structure of the information representation;
storing an information representation template for each combination of the information representation grammar and the support information type, the information representation template being a template used for generation of an information representation pattern being a program code for implementing a function of extracting the extraction target;
identifying the information representation template to be used for the generation of the information representation pattern to be used for extraction of the extraction target from the atypycal document, based on the information representation grammar and the support information type identified for the information representation.

15. The information representation structure analysis method according to claim 14, causing the information processing device to further execute steps of:
generating a screen for obtaining the extraction target and the basis information, presenting the screen to a user, and receiving the extraction target and the basis information from the user via the screen; and
storing the obtained extraction target and basis information.

16. The information representation structure analysis method according to claim 14, causing the information processing device to further execute a step of:
generating the information representation pattern by applying the extraction target and the basis information to the identified information representation template.

17. The information representation structure analysis device according to claim 1, further comprising an information representation pattern generation part configured to generate the information representation pattern by applying the extraction target and the basis information to the identified information representation template.
